(19) United States
(12) Patent Application Publication
(10) Pub. No.: US 2003/0172953 A1
(43) Pub. Date: Sep. 18, 2003

(54) Method of treating inner wall of apparatus

(76) Inventors: Koji Teranishi, Kanagawa (JP); Yasuyuki Suzuki, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/386,696

(22) Filed: Mar. 13, 2003

(30) Foreign Application Priority Data
Mar. 14, 2002 (JP) 070221/2002

(51) Int. Cl. B08B 7/00

(52) U.S. Cl. 134/1.1; 134/1.2

(57) ABSTRACT

The method of treating an inner wall of a vacuum apparatus equipped with a vacuum chamber, a pump for depressurizing an interior of the vacuum chamber and an electric power source for supplying electric power for generating discharge in the vacuum chamber, comprises the steps of depressurizing the interior of the vacuum chamber; introducing a discharge raw material gas into the depressurized interior of the vacuum chamber; supplying the electric power from the electric power source and converting the discharge raw material gas into a plasma to generate active species; and treating the inner wall of the vacuum apparatus with the active species to reduce amounts of an off-gas and an organic matter which are exhausted from the inner wall.

### BACKGROUND OF THE INVENTION

1. Field of the Invention

The present invention relates to a method of treating an inner wall etc. of a vacuum apparatus. The method of the present invention is suitable particularly for the treatment of an inner wall of a film-forming apparatus which performs film formation on the surface of an optical element for use in a semiconductor exposure system etc.

2. Related Background Art

For the past several years, a semiconductor exposure system called a stepper has been used in techniques for exposing or transferring micropatterns of integrated circuits. With high integration design of large scale integration (LSI) circuits, wavelength has become increasingly short to use an ArF maximizer (193 nm) and further to an F₂ eximizer (157 nm) in exposure light sources for these techniques.

It has been proposed to use fluorspar (CaF₂) having a better transmissivity as a material for optical elements used in the above-described stepper. The number of lenses mounted on such a stepper as described above is large. Therefore, even when the transmissivity loss per lens is small, a combination of a large number of lenses causes a large transmissivity loss, resulting in a decrease in the amount of light on an irradiated surface. Therefore, reducing transmissivity losses of not only of optical thin films, but also of optical materials is an essential object.

On the other hand, the transmissivity of a material (a base member) for an optical element as described above varies in a manner sensitive to the surface condition. Usually, when base members of these optical elements are allowed to stand in the atmosphere, adhering substances considered to be organic components of the atmosphere adhere to the surface gradually, causing optical characteristics to vary. In particular, transmissivity has a large tendency to vary and the result that transmissivity decreases due to these adhering substances has also been obtained. Such a decrease in transmissivity occurs especially remarkably in the ultraviolet light region. When these variations take place, there occurs the problem that optical equipment such as a stepper cannot obtain desired performance. For this reason, a method as described, for example, in Japanese Patent Application Laid-Open No. 11-116281 has so far been proposed as a method of cleaning optical elements.

However, when the surface of an optical element is contaminated within a film-forming apparatus which forms films such as optical thin films, an optical thin film is formed on the surface after contamination or a contaminant is taken into an optical thin film. Therefore, it is considerably difficult to remove this contaminant after film formation.

On the other hand, as a method of removing a contaminant within a film-forming apparatus, a cleaning method which involves removing chlorine molecules physically absorbed in the interior of a vacuum chamber as chlorinated hydrogen is proposed in Japanese Patent Application Laid-Open No. 6-84867. In this method, hydrogen gas is introduced during the evacuation of the interior of a vacuum chamber and a contaminate is caused to react by the heating of the interior of the vacuum chamber, thereby removing the contaminant. Furthermore, a similar method is also described in Japanese Patent Application Laid-Open No. 9-256178.

However, the application of the above-described methods is limited only to the etching process. Also, it is unknown whether a sufficient effect can be obtained in the case of the adsorption of organic matter and other elements.

### SUMMARY OF THE INVENTION

An object of the present invention is to solve the above-described problems of the prior art and provide a method of treating an inner wall of an apparatus capable of removing a contaminant within a vacuum apparatus such as a film-forming apparatus.

The above-described object can be achieved by providing a method of treating an inner wall of a vacuum apparatus equipped with a vacuum chamber, a pump for depressurizing an interior of the vacuum chamber and an electric power source for supplying electric power for generating discharge in the vacuum chamber, comprising the steps of:

depressurizing the interior of the vacuum chamber;

introducing a discharge raw material gas into the depressurized interior of the vacuum chamber;

supplying the electric power from the electric power source and converting the discharge raw material gas into a plasma to generate active species; and

treating the inner wall of the vacuum apparatus with the active species to reduce amounts of an off-gas and an organic matter which are exhausted from the inner wall.

In the above-described method, it is preferable that the treating of the inner wall with the active species is performed while heating the interior of the apparatus.

In the above-described method, it is preferable that the discharge raw material gas consists of a gas containing fluorine.

In the above-described method, it is preferable that the vacuum apparatus is a film-forming apparatus.

In the above-described method, it is preferable that the vacuum apparatus is a lens-barrel for an exposure apparatus.

### BRIEF DESCRIPTION OF THE DRAWINGS

FIG. 1 is a schematic diagram showing a sputtering film-forming apparatus, which is an example of a vacuum apparatus to which the method of the present invention can be applied;

FIG. 2 is a graph showing the experiment results of Comparative Example 1;

FIG. 3 is a graph showing the experiment results of Comparative Example 2;

FIG. 4 is a graph showing the experiment results of Comparative Example 3;

FIG. 5 is a graph showing the experiment results of Example 1;

FIG. 6 is a graph showing the experiment results of Example 2;

FIG. 7 is a graph showing the experiment results of Comparative Example 4; and

FIG. 8 is a graph showing the experiment results of Example 3.

### DESCRIPTION OF THE PREFERRED EMBODIMENTS

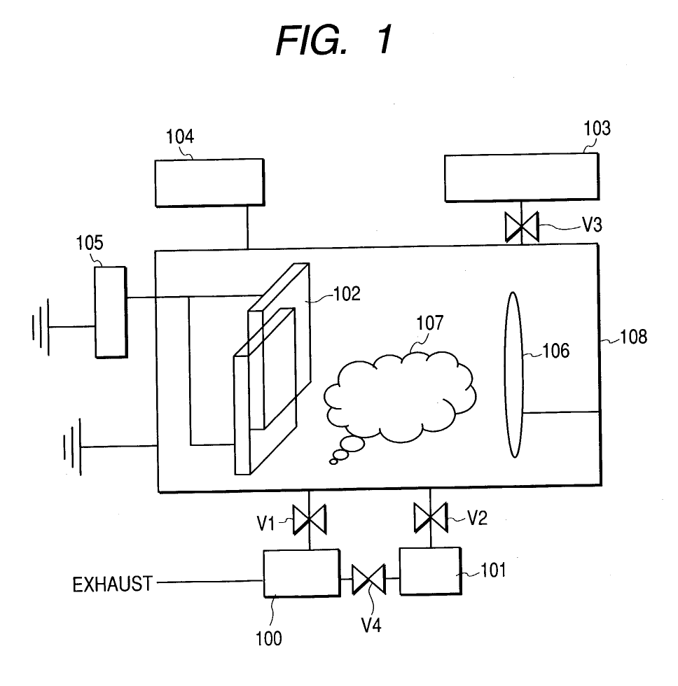

FIG. 1 is a schematic diagram showing a sputtering film-forming apparatus, which is an example of a vacuum apparatus to which the method of the present invention can be applied. In FIG. 1, the numeral 108 denotes a vacuum chamber. Within the vacuum chamber 108, a sputtering target 102 and a substrate 106 on which a film is to be deposited are placed. An oil-less pump 100 is connected to the vacuum chamber 108 through a valve V1 and a turbo pump 101 is connected thereto through a valve V2. Furthermore, the oil-less pump 100 and turbo pump 101 are connected to each other through a forth valve V4. Moreover, a cryogenic pump 103 is connected to the vacuum chamber 108 through a valve V3. A plasma raw material gas is supplied to the interior of this vacuum chamber 108 from gas supply means 105.

On the other hand, a power source 105 for plasma generation is connected to the sputtering target 102 placed within the vacuum chamber 108. A discharge 107 is generated by supplying an electric power to the sputtering target 102 from this power source 105 for plasma generation while supplying the plasma raw material gas to the interior of the vacuum chamber 108 from the above-described gas supply means 105, and a film is formed on the substrate.

The cleaning of an inner wall of the vacuum chamber 108 is performed by generating a discharge within the chamber in the same way as with film deposition, in the state of not placing the substrate 106 within the apparatus. By performing such cleaning, an organic substance adhered to the inner wall of the vacuum chamber can be removed and the amount of off-gas from the inner wall during film formation can be reduced.

In the moving parts of the above-described sputtering apparatus, nongrease bearings for the prevention of contamination are used. Furthermore, other parts are also formed to specifications which minimize the amount of an off-gas.

Examples of the present invention and Comparative examples will be concretely described below.

### COMPARATIVE EXAMPLE 1

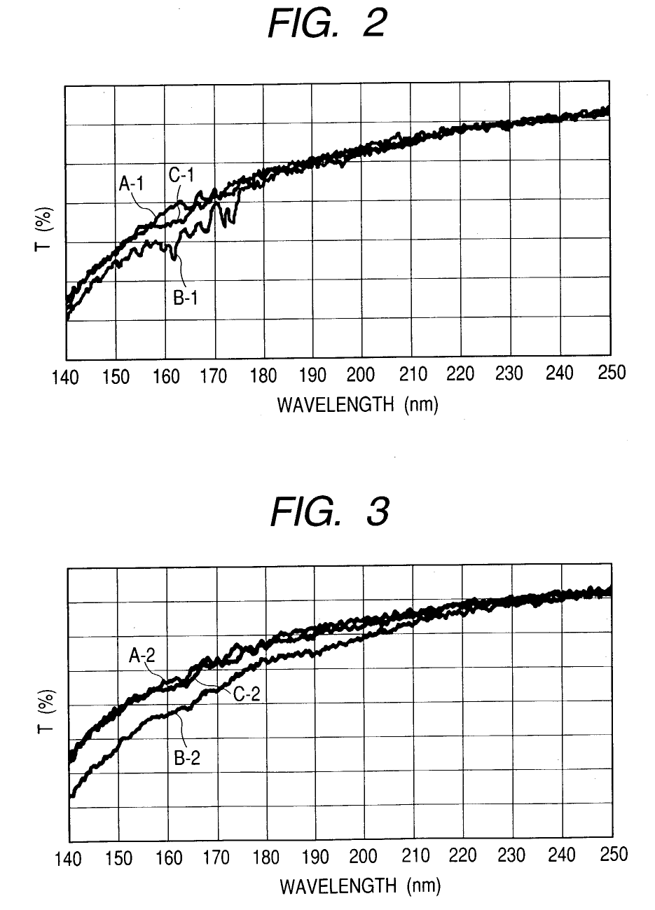

A CaF₂ glass substrate which has parallel polished surfaces and is 2 mm in thickness and 40 mm in diameter was cleaned with an organic cleaning agent which was prepared by mixing alcohol and ether at a ratio of 1:9 by volume. The cleaned CaF₂ glass substrate was further cleaned by use of a UV/O₃ apparatus (made by SAMCO). After that, the transmissivity of wavelength of the ultraviolet light region of this substrate was measured by use of a device of measuring vacuum ultraviolet spectroscopic characteristics. The result of this measurement is shown by A-1 in FIG. 2. In FIG. 2, the ordinate indicates transmissivity T (%) and the abscissa indicates wavelength (nm).

Next, the above-described substrate was put into a sputtering film-forming apparatus as shown in FIG. 1 and evacuation was performed from the atmosphere to 2×10⁻² Pa by use of the oil-less pump 100 alone. After that, CDA (clean dry air) was introduced into the interior of the chamber and the interior of the chamber was returned to the atmospheric pressure. After that, the CaF₂ glass substrate which had been put into the chamber was taken out. And the transmissivity of the taken-out substrate was measured by use of the device of measuring vacuum ultraviolet spectroscopic characteristics in the same manner as described above. The result of the measurement is shown by B-1 in FIG. 2. Variations in transmissivity were observed by comparing this result with the measuring result shown by A-1.

Furthermore, the CaF₂ glass substrate which had been subjected to the above-described treatment was again put into the UV/O₃ apparatus and cleaning was performed for 30 minutes. And the transmissivity of the substrate which had been taken out of the UV/O₃ apparatus was measured by use of the device of measuring vacuum ultraviolet spectroscopic characteristics in the same manner as described above. The result of this measurement is shown by C-1 in FIG. 2.

From the results shown in FIG. 2, it was ascertained that the transmissivity (B-1) after introducing this substrate into the film-forming apparatus and performing rough evacuation treatment (evacuation to 1×10⁻² Pa) worsened compared with the transmissivity (A-1) of the substrate which was cleaned with an organic cleaning agent and by use of the UV/O₃ apparatus. This result is described in further detail. That is, although the worsening of transmissivity is not ascertained with respect to the ArF wavelength (193 nm), the contamination of the CaF₂ glass substrate could be clearly ascertained with respect to the F₂ wavelength (157 nm)

Furthermore, from the fact that the transmissivity (C-1) recovered to the initial state when this CaF₂ glass substrate which had been contaminated and whose transmissivity had decreased in the 157 nm region was cleaned for about 30 minutes within the UV/O₃ apparatus, it might be thought that an organic substance adhered to or adsorbed the surface of the CaF₂ glass substrate.

Incidentally, in the vicinity of 160 nm in FIG. 2, values show variations due to the effect of emission lines of a heavy hydrogen lamp used as the light source of the spectroscope.

### COMPARATIVE EXAMPLE 2

In the same way as in Comparative Example 1, a CaF₂ glass substrate 2 mm in thickness and 40 mm in diameter was cleaned with an organic cleaning agent which was prepared by mixing alcohol and ether at a ratio of 1:9 by volume. The cleaned CaF₂ glass substrate was further cleaned by use of a UV/O₃ apparatus (made by SAMCO). After that, the transmissivity of wavelength of the ultraviolet light region of this substrate was measured by use of the device of measuring vacuum ultraviolet spectroscopic characteristics. The result of this measurement is shown by A-2 in FIG. 3. In FIG. 3, the ordinate indicates transmissivity T (%) and the abscissa indicates wavelength (nm).

Next, the above-described substrate was put into a sputtering film-forming apparatus as shown in FIG. 1 and evacuation was performed from the atmosphere to 2×10⁻² Pa by use of the oil-less pump 100 alone. After that, the vacuum chamber was connected to the cryogenic pump 103 and the interior of the apparatus was evacuated to a high vacuum (6×10⁻⁵ Pa). After that, CDA (clean dry air) was introduced into the chamber and the interior of the chamber was returned to the atmospheric pressure. After that, the CaF₂ glass substrate which had been put into the chamber was taken out. And the transmissivity of the taken-out substrate was measured by use of the device of measuring vacuum ultraviolet spectroscopic characteristics in the same manner as described above. The result of the measurement is shown by B-2 in FIG. 2. Variations in transmissivity were observed by comparing this result with the measuring result shown by A-2.

From the above-described result it was ascertained that the transmissivity worsens further toward the long wavelength side compared with the case of Example 1 and it became clear that also in the 193 nm region, the state of worsening has become a not negligible condition. It might be thought that this is because an off-gas from the inner wall of the chamber or members used in the interior adhered to the CaF₂ glass substrate, and in the comparison with Example 1, it can be said that this gas must be an organic substance.

Furthermore, the CaF₂ glass substrate which had been subjected to the above-described treatment was again put into the UV/O₃ apparatus and cleaning was performed for 30 minutes. And the transmissivity of the substrate which had been taken out of the UV/O₃ apparatus was measured by use of the device of measuring vacuum ultraviolet spectroscopic characteristics in the same manner as described above. The result of this measurement is shown by C-2 in FIG. 3.

### COMPARATIVE EXAMPLE 3

First, a CaF₂ glass substrate cut from the same crystal as used in Comparative Example 1 was prepared. Next, this substrate was cleaned with an organic cleaning agent which was prepared by mixing alcohol and ether at a ratio of 1:9 by volume. After that, this substrate was cleaned for a long time by use of a UV/O₃ apparatus (made by SAMCO) until the transmissivity reached a level of saturation (until the substrate showed a transmissivity of such a degree that internal absorption can be neglected).

Next, by use of the film-forming apparatus shown in FIG. 1, a fluoride of low refractive index and a fluoride of high refractive index were formed on the above-described cleaned substrate so as to form a film of three-layer structure and an antireflection film for use at 193 nm was thus formed.

For the film formation, the oil-less pump 100 was first started, the rough evacuation valve V1 was opened and the rough evacuation of the interior of the vacuum chamber was performed. After that, the valve V1 was closed, the main valve V3 was then opened and the interior of the vacuum chamber was highly evacuated to a prescribed pressure by use of the cryogenic pump 103. After that, the main valve V3 was closed, the forth valve V4 was opened, the second main valve V2 was opened, and the interior of the vacuum chamber was evacuated by use of the turbo pump 101. Subsequently, the plasma raw material gas was introduced from the gas supply means 104 into the chamber while controlling the gas flow rate by use of a mass flow controller.

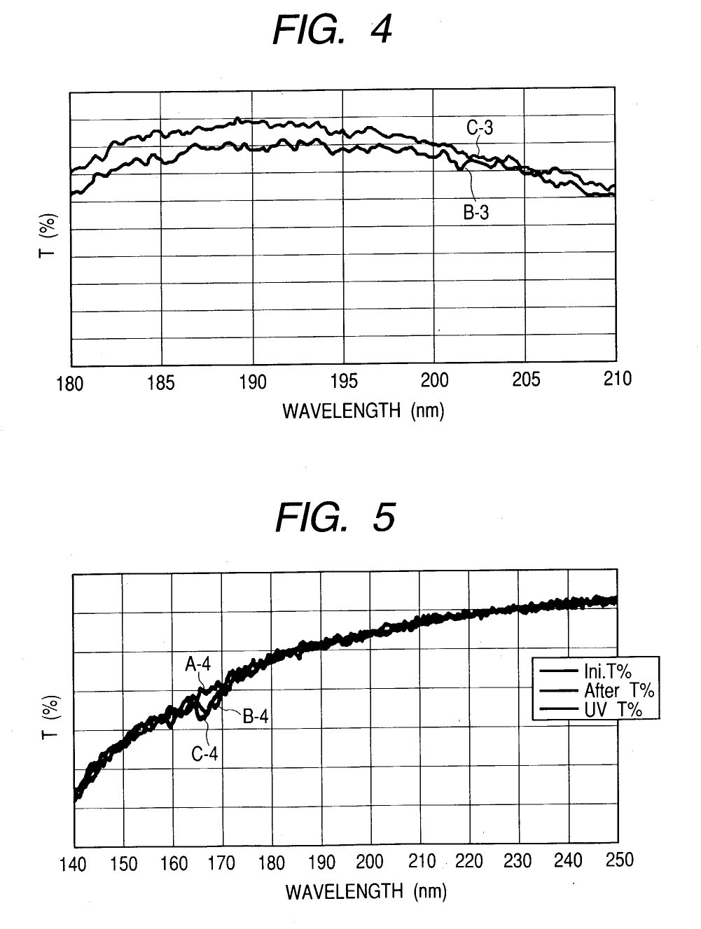

Next, discharge 107 was generated by supplying an electric power from the power source 105 for plasma generation to the sputtering target 102, the substrate 106 to be treated was subjected to plasma treatment, and a multilayer film was formed on both surfaces. After that, the interior of the chamber was returned to the atmospheric pressure by CDA and the substrate was then taken out. The transmissivity of the taken-out substrate was measured by use of a vacuum ultraviolet spectroscope. The result of the measurement is shown by B-3 in FIG. 4. In FIG. 4, the ordinate indicates transmissivity T (%) and the abscissa indicates wavelength (nm).

Next, the substrate for which the measurement of the transmissivity had been completed was introduced into the UV/O₃ apparatus and an antireflection film after formation was cleaned. And the transmissivity was measured by use of a vacuum ultraviolet spectroscope in the same manner as described above. The result of this measurement is shown by C-3 in FIG. 4.

In FIG. 4, a comparison was made between B-3 and C-3. As a result, it could be ascertained that the transmissivity after the cleaning by use of the UV/O₃ apparatus improved in comparison with the transmissivity immediately after film formation. Similarly as in Comparative Examples 1 and 2, there is a high possibility that the cause of this result is contamination of the interior of the apparatus, and it was ascertained by this experiment that the interior of the apparatus had been contaminated with an organic substance.

Furthermore, there is a possibility that the contaminant which adhered to the surface of the CaF₂ glass substrate during the initial evacuation worsens the transmissivity by interposing the contaminant between the film and the surface of the CaF₂ glass substrate.

### EXAMPLE 1

From the experiments of Comparative Examples 1 to 3, it was ascertained that by performing evacuation of the interior of the apparatus an organic substance adheres to and adsorbs the surface of the CaF₂ glass substrate or the surface of the film, thereby worsening the transmissivity.

Accordingly, the present inventors conducted the following examination in order to remove such contamination of the apparatus.

The apparatus of FIG. 1 was used. The rough evacuation valve V1 was opened and the interior of the vacuum chamber was subjected to rough evacuation treatment. After that, the valve V1 was closed. After that, the main valve V3 was opened, the interior of the vacuum chamber was highly evacuated by use of the cryogenic pump 103, and evacuation was performed to a predetermined pressure. After that, the main valve V3 was closed, the forth valve V4 was opened, the second main valve V2 was opened, and the interior of the vacuum chamber was evacuated to a vacuum by use of the turbo pump 101. Subsequently, an Ar-diluted F₂ gas as the plasma raw material gas was introduced from the gas supply means 104 into the vacuum chamber while controlling the gas flow rate by use of a mass flow controller. After that, discharge 107 was generated by supplying an electric power from the power source 105 for plasma generation to the sputtering target 102, and the cleaning of the apparatus was performed by allowing the discharge generated for about 10 hours to be kept.

Next, a CaF₂ glass substrate cut from the same crystal as used in Comparative Example 1 was prepared. This substrate was cleaned with an organic cleaning agent which was prepared by mixing alcohol and ether at a ratio of 1:9 by volume. After that, this substrate was cleaned for a long time by use of a UV/O₃ apparatus (made by SAMCO) until the transmissivity reached a level of saturation (until the substrate showed a transmissivity of such a degree that internal absorption can be neglected). After that, the transmissivity of the wavelength of ultraviolet light region of this substrate was measured by use of the device of measuring vacuum ultraviolet spectroscopic characteristics. The result of the measurement is shown by A-4 in FIG. 5. In FIG. 5, the ordinate indicates transmissivity T (%) and the abscissa indicates wavelength (nm).

Next, the above-described substrate was introduced into the sputtering film-forming apparatus which had been subjected to cleaning treatment by plasma discharge. And after evacuation to a vacuum by use of the oil-less pump 100, evacuation was performed for 3 hours by use of the cryogenic pump 103. After that, the interior of the chamber was returned to the atmospheric pressure by CDA and the substrate was then taken out. And the transmissivity of the taken-out substrate was measured by use of the device of measuring vacuum ultraviolet spectroscopic characteristics. The result of the measurement is shown by B-4 in FIG. 5.

Furthermore, the CaF₂ glass substrate subjected to the above-described treatment was again put into the UV/O₃ apparatus and cleaning was performed for 30 minutes. And the transmissivity of the substrate which had been taken out of the UV/O₃ apparatus was measured by use of the device of measuring vacuum ultraviolet spectroscopic characteristics in the same manner as described above. The result of this measurement is shown by C-4 in FIG. 5.

The result shown in FIG. 5 reveals that the transmissivity (B-4) of the substrate introduced into the sputtering film-forming apparatus scarcely changes from the transmissivity (A-4) before the introduction. It is apparent from this that the inner wall of the apparatus was cleaned by the above-described plasma treatment, with the result that the substrate was not contaminated. It might be thought that in plasma cleaning the active species of F dissociated by the plasma etched or passivated an organic substance adhered to the inner wall of the vacuum chamber and the members used in the interior, thereby making it possible to eliminate the effect of the contaminant on the substrate.

### EXAMPLE 2

First, a CaF₂ glass substrate cut from the same crystal as used in Example 1 was prepared. Next, this substrate was cleaned with an organic cleaning agent which was prepared by mixing alcohol and ether at a ratio of 1:9 by volume. After that, this substrate was cleaned for a long time by use of a UV/O₃ apparatus (made by SAMCO) until the transmissivity reached a level of saturation (until the substrate showed a transmissivity of such a degree that internal absorption can be neglected).

Next, the above-described cleaned substrate was introduced into the sputtering film-forming apparatus shown in FIG. 1 which had been cleaned by plasma treatment in the same manner as in Example 1. And a fluoride of low refractive index and a fluoride of high refractive index were formed on this substrate so as to form a film of three-layer structure and an antireflection film for use at 193 nm was thus formed.

For the film formation, the oil-less pump 100 was first started, the rough evacuation valve V1 was opened, and the rough evacuation of the interior of the vacuum chamber was performed. After that, the valve V1 was closed, the main valve V3 was then opened, and the interior of the vacuum chamber was highly evacuated to a predetermined pressure by use of the cryogenic pump 103. After that, the main valve V3 was closed, the forth valve V4 was opened, the second main valve V2 was opened, and the interior of the vacuum chamber was evacuated by use of the turbo pump 101. Subsequently, the plasma raw material gas was introduced from the gas supply means 104 into the chamber while controlling the gas flow rate by use of a mass flow controller.

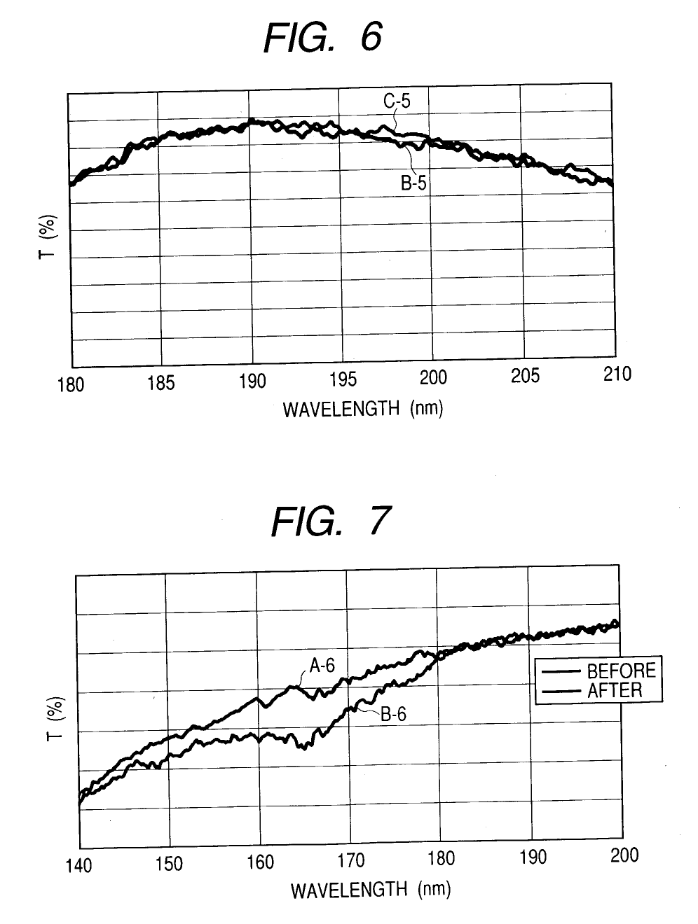

Next, discharge 107 was generated by supplying an electric power from the power source 105 for plasma generation to the sputtering target 102, the substrate 106 to be treated was subjected to plasma treatment, and a multilayer film was formed on both surfaces. After that, the interior of the chamber was returned to the atmospheric pressure by CDA and the substrate was then taken out. The transmissivity of the taken-out substrate was measured by use of a vacuum ultraviolet spectroscope. The result of the measurement is shown by B-5 in FIG. 6. In FIG. 6, the ordinate indicates transmissivity T (%) and the abscissa indicates wavelength (nm).

Next, the substrate for which the measurement of the transmissivity had been completed was introduced into the UV/O₃ apparatus and an antireflection film after film formation was cleaned. And the transmissivity was measured by use of a vacuum ultraviolet spectroscope in the same manner as described above. The result of this measurement is shown by C-5 in FIG. 6.

From the results shown in FIG. 6, a difference could scarcely been observed between the transmissivity of the substrate after film formation and the transmissivity of the substrate cleaned later by use of the UV/O₃ apparatus. Also from this fact, it could be ascertained that contamination had been eliminated from the inner wall of the vacuum chamber and the used members by the cleaning of the inner wall of the vacuum chamber by plasma treatment.

### COMPARATIVE EXAMPLE 4

First, the transmissivity of a CaF₂ glass substrate was measured by use of the device of measuring vacuum ultraviolet spectroscopic characteristics. The result of the measurement is shown by A-6 in FIG. 7. In FIG. 7, the ordinate indicates transmissivity T (%) and the abscissa indicates wavelength (nm).

Next, the above-described substrate whose transmissivity had been measured beforehand was installed in the interior of a lens-barrel for an exposure apparatus, N₂ purge was carried out after that, and the substrate was allowed to stand for 2 hours. After that, the substrate was removed from the lens-barrel and the transmissivity of the substrate was measured by use of the device of measuring vacuum ultraviolet spectroscopic characteristics in the same manner as described above. The result of this measurement is shown by B-6 in FIG. 7. As a result, the present inventors obtained the knowledge that the worsening of transmissivity is caused only by installing a CaF₂ glass substrate within a lens-barrel for 2 hours.

### EXAMPLE 3

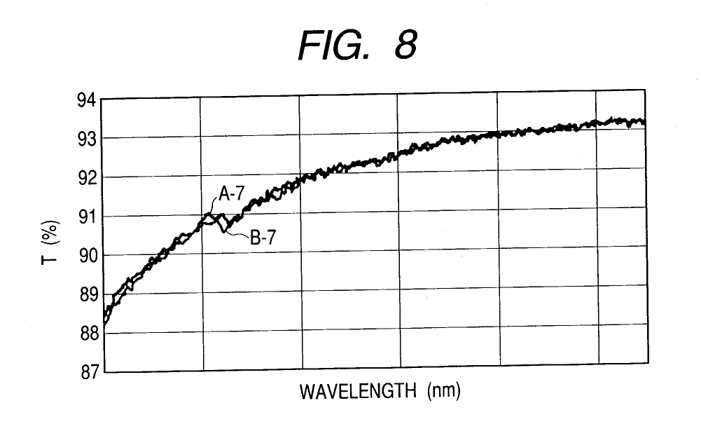

The transmissivity of a CaF₂ glass substrate was measured by use of the device of measuring vacuum ultraviolet spectroscopic characteristics. The result of this measurement is shown by A-7 in FIG. 8. In FIG. 8, the ordinate indicates transmissivity T (%) and the abscissa indicates wavelength (nm).

Next, the interior of a lens-barrel for an exposure apparatus was purged with F₂ gas for 5 hours. After that, the above-described substrate whose transmissivity had been measured beforehand was installed. After that, N₂ purge was carried out and the substrate was allowed to stand for 2 hours. After that, the substrate was removed from the lens-barrel and the transmissivity of the substrate was measured by use of the device of measuring vacuum ultraviolet spectroscopic characteristics in the same manner as described above. The result of this measurement is shown by B-7 in FIG. 8. Thus, by purging the interior of the lens-barrel with F₂ gas beforehand, the worsening of the transmissivity of the substrate could be almost completely prevented.

What is claimed is:

1. A method of treating an inner wall of a vacuum apparatus equipped with a vacuum chamber, a pump for depressurizing an interior of the vacuum chamber and an electric power source for supplying electric power for generating discharge in the vacuum chamber, comprising the steps of:
depressurizing the interior of the vacuum chamber;
introducing a discharge raw material gas into the depressurized interior of the vacuum chamber;
supplying the electric power from the electric power source and converting the discharge raw material gas into a plasma to generate active species; and
treating the inner wall of the vacuum apparatus with the active species to reduce amounts of an off-gas and an organic matter which are exhausted from the inner wall.

2. The method according to claim 1, wherein the treating of the inner wall with the active species is performed while heating the interior of the apparatus.

3. The method according to claim 1, wherein the discharge raw material gas consists of a gas containing fluorine.

4. The method according to claim 1, wherein the vacuum apparatus is a film-forming apparatus.

5. The method according to claim 1, wherein the vacuum apparatus comprises a lens-barrel for an exposure apparatus.
